(19) United States
(12) Patent Application Publication
(10) Pub. No.: US 2022/0390260 A1
(43) Pub. Date: Dec. 8, 2022

(54) DEVICE, SYSTEM AND METHOD FOR COUPLING ARBITRARY SENSORS TO FIBER OPTIC CABLES

(71) Applicant: ELBIT SYSTEMS C4I AND CYBER LTD., Netanya (IL)

(72) Inventors: Haniel GABAI, Netanya (IL); Andrey BOGOMOLOV, Netanya (IL)

(73) Assignee: ELBIT SYSTEMS C4I AND CYBER LTD., Netanya (IL)

(21) Appl. No.: 17/891,213

(22) Filed: Aug. 19, 2022

Related U.S. Application Data
(63) Continuation of application No. PCT/IL2021/050190, filed on Feb. 18, 2021.
(60) Provisional application No. 63/122,186, filed on Dec. 7, 2020.

(30) Foreign Application Priority Data
Feb. 19, 2020 (IL) 272756

(51) Int. Cl. G01D 5/26; G01N 21/65; G01D 5/353; G01H 9/00; G01K 11/32

(52) U.S. Cl. CPC G01D 5/268; G01N 21/65; G01D 5/35377; G01H 9/004; G01K 11/32

(57) ABSTRACT

A device for coupling a sensor to a fiber optic cable including at least one optical fiber, the device may include an activation unit couplable to a known coupling location along the fiber optic cable and configured to: receive an analog sensor output signal from the sensor and change one or more properties of at least one of: one or more optical wave propagating through the at least one optical fiber and the at least one optical fiber, with respect to the analog output signal, while maintaining at least a portion of a spectral content of the analog sensor output signal during at least a portion of time.

### CROSS REFERENCE TO RELATED APPLICATIONS

This application is a continuation of PCT Application No. PCT/IL2021/050190 filed on Feb. 18, 2021, which claims the benefit of U.S. Provisional Patent Application No. 63/122,186 filed on Dec. 7, 2020, and of Israeli Patent Application No. 272756 filed on Feb. 19, 2020, all of which are incorporated herein by reference in their entireties.

### FIELD OF THE INVENTION

The present invention relates to the field of distributed fiber sensing, and more particularly, to devices, systems and methods for coupling arbitrary sensors to fiber optic cables.

### BACKGROUND OF THE INVENTION

Distributed fiber sensing systems typically use optical fibers to provide distributed strain and/or temperature sensing. Distributed fiber sensing systems typically includes one or more transmitter/receiver units (e.g., generally referred hereinafter as “an interrogator”) connected to one or two ends of an optical fiber. The interrogator typically launches light into the optical fiber, detects light and analyzes the detected light such that each section of the optical fiber serves as an independent sensing section. In this manner, the optical fiber is transformed into multiple sensing sections each defined by its length along the optical fiber.

Each of the sensing sections (e.g., due to strain and/or temperature) may be perturbed due to, for example, a physical change in an environment of the respective sensing section. For example, walking, talking, etc. in a vicinity of the respective sensing section of the optical fiber may strain the respective sensing section thereof. In this manner, the physical changes may be sensed by the optical fiber along its entire length.

However, distributed fiber sensing systems are typically less sensitive to the environmental changes as compared to conventional sensors such as geophones, microphones, etc. This reduced sensitivity may be due to, for example, inefficient energetic coupling between the physical change to be sensed and the optical fiber. Another challenge may include distinguishing between signals originated by temperature and/or strain changes as both change an optical path of an interrogating optical probe.

Some methods and systems for enhancing the sensing of the environment by distributed fiber sensing systems are available.

For example, some systems utilize advanced interrogators. The advanced interrogators may be based on at least one of: Rayleigh scattering and non-linear optical effects such as Raman, Brillouin, etc. However, the advanced interrogators are expensive and may require a sterile environment in order to operate properly. For example, the advanced interrogators may require insulation of vibrations, stabilization of an ambient temperature, a reduction of exposure to radiating sources, etc. Accordingly, systems utilizing the advanced interrogators are typically more suitable to be used at optical laboratories or dedicated rooms for research activity. Furthermore, such systems cannot improve the energetic coupling between the physical change to be sensed and the optical fiber and are mostly limited to sensing of strain and/or temperature only.

In another example, some systems utilize dedicated sensing optical fibers and/or cables. However, the design of such dedicated sensing solutions strongly depends on, for example, parameters of the sounding environment such as the ground on which the fiber is expected to be deployed. The parameters of the ground in a typical terrain may drastically change within a range of tens of meters. Accordingly, the effective length of such dedicated sensing optical fibers is typically limited to tens of meters, while designing longer fibers/cables is expensive and challenging to implement. Furthermore, such systems are limited to sensing of strain and/or temperature only.

In another example, some systems utilize optical fibers with optical resonators embedded therein at predetermined locations along the optical fibers (e.g., Fiber Bragg Gratings). The sensing of the environment in such systems is thus limited to location of the resonators thereof. However, deploying kilometers long sensing fiber (with many embedded resonators at their exact coordinates in the field may be difficult and expensive. Furthermore, the optical resonators may provide a significant reflection of light travelling through the optical fibers, which may limit the sensing length along the optical fiber for a given light power. Such systems are also limited to sensing of strain and/or temperature only.

In another example, some systems utilize optical fibers that are being wrapped around mechanical resonators in predetermined locations along the optical fibers. However, mechanical resonators are typically designed to sense very specified conditions (e.g., mechanical vibrations in a limited frequency range). Moreover, wrapping of the optical fiber around the mechanical resonators may increase an attenuation of the optical fibers and/or damage the optical fibers. In addition, coupling thereof to rigid/armored optical cables (as in operational deployment) is difficult to implement and may significantly increase installation costs.

In another example, some systems utilize coupling devices that are used to couple conventional sensors (e.g., such as geophones, microphones, etc.) to the optical fibers at predetermined locations along the optical fibers. These coupling devices typically utilize acoustic transducers capable of transmitting acoustic waves. Electrical signals received from the conventional sensors coupled to the coupling devices are typically modulated/encoded in a resonance frequency of the acoustic transducers which generate and apply modulated/encoded acoustic waves in the resonance frequency thereof to strain the optical fibers at the predetermined locations along the optical fiber. However, such systems require additional processing of data received from the optical fibers in order to be able to interpret information obtained by the conventional sensor and/or require specially designed interrogators or modification of existing interrogators.

### SUMMARY OF THE INVENTION

Some embodiments of the present invention may provide a device for coupling a sensor to a fiber optic cable including at least one optical fiber, the device may include: an activation unit couplable to a known coupling location along the fiber optic cable and configured to: receive an analog sensor output signal from the sensor and change one or more properties of at least one of: one or more optical wave propagating through the at least one optical fiber and the at least one optical fiber, with respect to the analog sensor output signal, while maintaining at least a portion of a spectral content of the analog sensor output signal during at least a portion of time.

In some embodiments, the device may include an analog preprocessing unit configured to preprocess the analog sensor output signal and provide an analog activation signal that is correlative with the analog sensor output signal, wherein the activation unit is configured to change the one or more properties with respect to the analog activation signal.

In some embodiments, the analog preprocessing unit may include a pre-amplifier sub-unit configured to pre-amplify the analog sensor output signal.

In some embodiments, the analog preprocessing unit may include an analog spectral content adapter sub-unit configured to at least one of: shift the spectral content by a known shift frequency value and dividing/multiplying the spectral content by a known division/multiplication value.

In some embodiments, the analog preprocessing unit may include a power source for supplying power to the analog preprocessing unit.

In some embodiments, the activation unit may include one or more vibrational members externally couplable to the coupling location along the fiber optic cable, the one or more vibrational members vibrate in response to the analog activation signal thereby vibrating the fiber optic cable at least in the coupling location.

In some embodiments, the activation unit is configured to be in-line coupled at the coupling location along the fiber optic cable, the activation unit may include: an activation unit optical fiber; two optical couplers each at one of ends of the activation unit optical fiber, the optical couplers are adapted to couple the activation unit optical fiber to the at least one optical fiber of the fiber optic cable; and one or more vibrational members coupled to the activation unit optical fiber, the one or more vibrational members vibrate in response to the analog activation signal thereby vibrating the activation unit optical fiber.

In some embodiments, the one or more vibrational members are made of one of: piezoelectric materials, electrostriction materials and electromagnetic effectible materials.

In some embodiments, the sensor is a sensor capable of generating a transient sensor output signal.

Some embodiments of the present invention may provide a fiber optic cable of one or more optical fibers that may include one or more devices of described hereinabove, wherein the activation unit of each of the one or more devices is rigidly coupled to the fiber optic cable at a known coupling location.

Some embodiments of the present invention may provide a distributed fiber sensing system that may include: (a) one of: (i) a fiber optic cable of one or more optical fibers, and one or more devices described hereinabove, the activation unit of each of the one or more devices is couplable to the fiber optic cable at a known coupling location; and (ii) a fiber optic cable that may include one or more devices described hereinabove, wherein the activation unit of each of the one or more devices is rigidly coupled to the fiber optic cable at a known coupling location; and (b) an interrogator.

Some embodiments of the present invention may provide a method of distributed fiber sensing, the method may include: transmitting, by an interrogator, one or more optical waves per one interrogation cycle into at least one optical fiber of a fiber optic cable; coupling one or more devices to the fiber optic cable at one or more known coupling locations along the fiber optic cable; connecting one or more sensors each to one of the one or more devices; receiving, by each of at least some of the one or more devices, an analog sensor output signal generatable by the respective sensor in response to sensing an environmental change in a vicinity thereof; and inducing, by each of at least some of the one or more devices, a change of one or more properties of at least one of: one or more optical wave propagating through the at least one optical fiber and the at least one optical fiber, with respect to the analog sensor output signal, while maintaining at least a portion of a spectral content of the analog sensor output signal during at least a portion of time.

Some embodiments may include preprocessing, by each of at least some of the one or more devices, the respective analog sensor output signal to provide an analog activation signal that is correlative with the respective analog sensor output signal; and inducing, by each of at least some of the one or more devices, the change of the one or more properties with respect to the analog activation signal.

Some embodiments may include pre-amplifying, by each of at least some of the one or more devices, the respective analog activation signal.

Some embodiments may include, by each of at least some of the one or more devices, at least one of: shifting a spectral content of the respective analog sensor output signal by a known shift frequency value and dividing/multiplying the spectral content of the respective analog sensor output signal by a known division/multiplication value.

Some embodiments may include detecting and analyzing, by the interrogator, the one or more optical waves from at least some points along the fiber optic cable.

Some embodiments may include detecting, by the interrogator, based on the analysis thereof, the change induced by each of at least some of the one or more devices.

Some embodiments may include detecting, by the interrogator, based on the analysis thereof, whether at least one of the one or more sensors connected to at least of the one or more devices has sensed an environmental change that is above one or more thresholds.

Some embodiments may include identifying, by the interrogator, a sensing section of multiple sensing sections pre-defined by the interrogator along the fiber optic cable, in which the change has been induced by each of at least some of the one or more devices.

Some embodiments may include coupling two or more devices in a single sensing section of the multiple sensing sections while eliminating crosstalk therebetween.

Some embodiments may include: at least one of shifting and dividing/multiplying a spectral content of the analog sensor output signal from at least one of two or more sensors coupled by at least one of the two or more devices to the fiber optic cable in the single sensing section thereof; and identifying, by the interrogator, which of the two or more sensors in the single sensing section has sensed the environmental change in a vicinity thereof.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1A is a schematic block diagram of a first embodiment of a device for coupling a sensor to a fiber optic cable, according to some embodiments of the invention;

FIG. 1B is a schematic block diagram of a second embodiment of a device for coupling a sensor to a fiber optic cable, according to some embodiments of the invention;

FIG. 2 is a schematic illustration of an activation unit for external coupling thereof to a fiber optic cable, according to some embodiments of the invention;

FIG. 3 is a schematic illustration of an activation unit for in-line coupling thereof to a fiber optic cable, according to some embodiments of the invention;

FIG. 4A is a schematic illustration of a device for coupling a sensor to a fiber optic cable, in operation in a distributed fiber sensing system, according to some embodiments of the invention;

FIG. 4B is a schematic illustration of multiple devices for coupling multiple sensor to a fiber optic cable, in operation in distributed fiber sensing system, according to some embodiments of the invention; and

FIG. 5 is a flowchart of a method of distributed fiber sensing, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Some embodiments of the present invention may provide a device for coupling an arbitrary sensor to a fiber optic cable including at least one optical fiber. According to some embodiments, the device may include an activation unit. The activation unit may be externally or in-line couplable to the fiber optic cable. The activation unit may receive an analog sensor output signal from the sensor. The activation unit may be configured to change one or more properties of at least one of: (i) one or more optical waves propagating through the at least one optical fiber, and (ii) the at least one optical fiber, with respect to the analog sensor output signal. In some embodiments, the activation unit may change the one or more properties of at least one of: (i) one or more optical waves propagating through the at least one optical fiber, and (ii) the at least one optical fiber, with respect to the analog sensor output signal while maintaining (or substantially maintaining) at least a portion of a content (e.g., a spectral content and/or a temporal content) of the analog sensor output signal. The content of the analog sensor output signal may include, for example, a spectral content thereof. For example, the spectral content of the analog sensor output signal may include at least one of: measures of magnitudes and phase shifts as function of frequency of the analog sensor output signal, ratios between frequencies and ratios between phase shifts of the analog sensor output signal, a complex representation of the Fourier Transform of the analog sensor output signal, etc. The content of the analog sensor output signal may include, for example, a temporal content thereof. For example, the temporal content of the analog sensor output signal may include, for example, morphological temporal variations of the analog sensor output signal, etc. In some embodiments, the activation unit may change the one or more properties of at least one of: (i) one or more optical waves propagating through the at least one optical fiber, and (ii) the at least one optical fiber, with respect to the analog sensor output signal while maintaining (or substantially maintaining) at least a portion of a content (e.g., a spectral content and/or a temporal content) of the analog sensor output signal during at least a portion of time. For example, in operation, the activation unit may maintain at least a portion of the content of the analog sensor output signal during at least a portion of operation time and/or during the entire operation time.

The device may be used in a distributed fiber sensing system. The change induced by the activation unit of the device may be correlative with the analog sensor output signal from the sensor. Accordingly, the change induced by the activation unit may be inherently detectable by any interrogator, independent of a type thereof. As no analog and/or digital encoding process is involved (e.g., analog to digital, binary encoding, etc.) the signal may be inherently extracted at an interrogation station without decoding manipulations. This may, for example, eliminate encoding errors and/or quantization noise (e.g., when the number of bits representing the signal is not high enough) typically involved in such decoding manipulations. In this manner, the device may be easily retrofitted to any operating distributed fiber sensing system, while eliminating (or substantially eliminating) a need in performing adaptations to the system (e.g., system design adaptations and/or algorithmic adaptations). In some embodiments, the analog preprocessing unit of the device may be capable of performing spectral content adaptation of the analog sensor output signal (e.g., while yet maintaining at least a portion of the spectral content thereof). The spectral content of the analog signal that is to be detected may be adapted at bandwidth detection capabilities of an arbitrary interrogator, for example via spectral shifting and/or frequency division, e.g., while maintaining (or substantially maintaining), for example, ratios between frequencies and ratios between phase shifts of the analog sensor output signal. This may, for example, enable performing Frequency-Division-Multiplexing (FDM) of several sensors to the same sensing section of multiple sensing sections of the fiber optic cable while eliminating crosstalk artifacts.

The device may enable coupling of a wide range of sensors to the fiber optic cable. For example, sensors that are capable of outputting transient sensor output signals may be coupled to the fiber optic cable using the device. Such sensors may, for example, include geophones, microphones, various chemical sensors. The device may also enable extending the field of distributed fiber sensing to new sensing regimes that cannot be sensed with current distributed fiber sensing systems. For example, the device may enable coupling of a radio antenna to the fiber optic cable. The device may, for example, provide good energetic coupling between the environmental change to be sensed and the fiber optic cable while enabling enhanced sensing capabilities.

In some embodiments, the device may be independent of an external power source. For example, the device may include one or more power sources capable of supplying power to the components thereof for a time period ranging between few months to few years.

Some embodiments of the present invention may include a fiber optic cable of one or more optical fibers, and one or more devices as described above, wherein the activation unit of each of the one or more devices is rigidly coupled (e.g., welded or soldered) to the fiber optic cable at a known coupling location.

Some embodiments of the present invention may provide a distributed fiber sensing system. The distributed fiber sensing system may include at least one of: one or more devices as described above, a fiber optic cable of one or more optical fibers, one or more sensors and an interrogator. In some embodiments, the distributed fiber sensing system may include the fiber optic cable and one or more devices as described above, wherein the activation unit of each of the one or more devices is rigidly coupled (e.g., welded or soldered) to the fiber optic cable at a known coupling location.

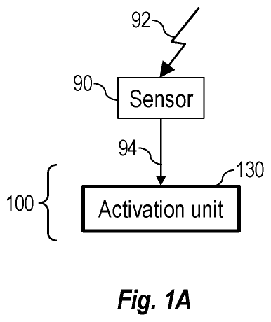

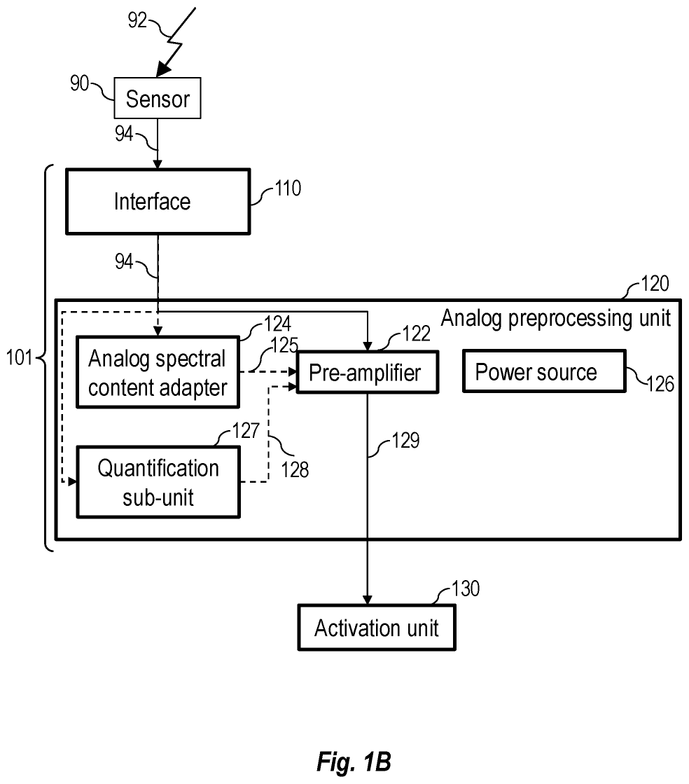

Reference is now made to FIG. 1A, which is a schematic block diagram of a first embodiment of a device 100 for coupling a sensor 90 to a fiber optic cable, according to some embodiments of the invention.

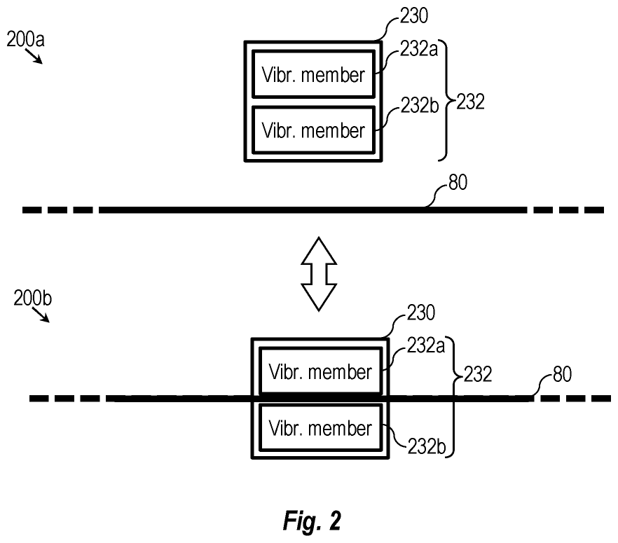

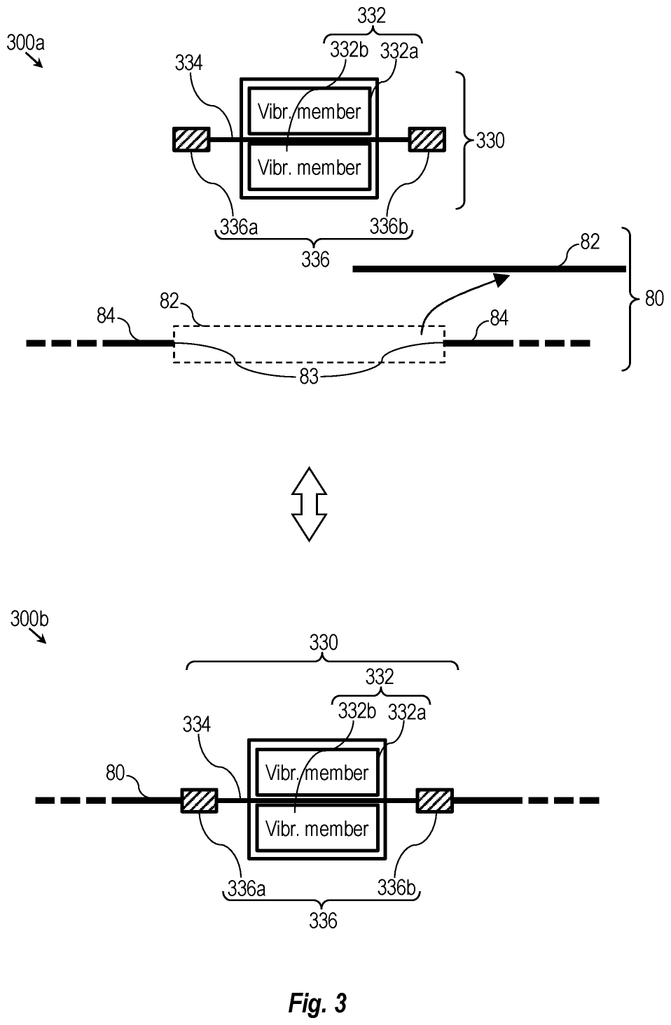

According to some embodiments, device 100 may include an activation unit 130. In various embodiments, activation unit 130 may be externally or in-line couplable to the fiber optic cable (e.g., as described below with respect to FIGS. 2 and 3, respectively). In some embodiments, activation unit 130 may be removably couplable to the fiber optic cable. Activation unit 130 may be connectable to a sensor 90.

Sensor 90 may be a conventional, arbitrary sensor (e.g., off-the-shelf sensor). Sensor 90 may, for example, be a geophone, a microphone (e.g., a dynamic microphone), a chemical sensor (e.g., impedance-change based chemical sensor), an accelerometer, a radio antenna, etc. In general, sensor 90 may be any sensor that has a transient sensor output signal. Sensor 90 may sense 92 an environmental change in a vicinity thereof and generate in response an analog sensor output signal 94 (e.g., as shown in FIG. 1A).

Activation unit 130 may receive analog sensor output signal 94 from sensor 90. The optical fiber cable may include at least one optical fiber. Activation unit 130 may be configured to change one or more properties of at least one of: (i) one or more optical waves propagating through the at least one optical fiber, and (ii) the at least one optical fiber, with respect to analog sensor output signal 94.

In some embodiments, activation unit 130 may change the one or more properties of at least one of: (i) one or more optical waves propagating through the at least one optical fiber, and (ii) the at least one optical fiber, with respect to analog sensor output signal 94 while maintaining (or substantially maintaining) at least a portion of a content of analog sensor output signal 94. The content of analog sensor output signal 94 may include, for example, a spectral content thereof. For example, the spectral content of analog sensor output signal 94 may include at least one of: measures of magnitudes and phase shifts as function of frequency of the analog sensor output signal, ratios between frequencies and ratios between phase shifts of the analog sensor output signal, a complex representation of the Fourier Transform of the analog sensor output signal, etc. The content of analog sensor output signal 94 may include, for example, a temporal content thereof. For example, the temporal content of analog sensor output signal 94 may include, for example, morphological temporal variations of the analog sensor output signal, etc.

In some embodiments, activation unit 130 may change the one or more properties of at least one of: (i) one or more optical waves propagating through the at least one optical fiber, and (ii) the at least one optical fiber, with respect to analog sensor output signal 94 while maintaining (or substantially maintaining) at least a portion of the content (e.g., the spectral content and/or the temporal content) of analog sensor output signal 94 during at least a portion of time. For example, in operation, activation unit 130 may maintain at least a portion of the content of the analog sensor output signal during at least a portion of operation time and/or during the entire operation time.

The properties of the optical wave(s) may include, for example, a phase, polarization, optical interference, etc. of the optical wave(s). The properties of the at least one optical fiber may, for example, include density, strain, etc. of the at least one optical fiber. In another example, the properties may include interaction of the optical wave(s) with respect to each other and/or with the at least one optical fiber.

Reference is now made to FIG. 1B, which is a schematic block diagram of a second embodiment of a device 101 for coupling a sensor 90 to a fiber optic cable, according to some embodiments of the invention.

According to some embodiments, device 101 may include an interface 110, an analog preprocessing unit 120 and an activation unit 130.

Interface 110 may connect a sensor 90 to device 101. Interface 110 may receive analog sensor output signal 94 from sensor 90 coupled thereto and transmit analog sensor output signal 94 to analog preprocessing unit 120.

Analog preprocessing unit 120 may preprocess analog sensor output signal 94 to provide an analog activation signal 129. In some embodiments, analog activation signal 129 may be correlative with analog sensor output signal 94. In some embodiments, analog activation signal 129 may maintain (or substantially maintain) at least a portion of the content (e.g., the spectral content and/or the temporal content) of the analog sensor output signal 94. Analog preprocessing unit 120 may transmit analog activation signal 129 to activation unit 130.

In some embodiments, analog preprocessing unit 120 may include a pre-amplifier sub-unit 122. Pre-amplifier sub-unit 122 may include one or more signal amplification circuits. Pre-amplifier sub-unit 122 may pre-amplify analog sensor output signal 94 by a known gain factor. Pre-amplifier sub-unit 122 may pre-amplify analog sensor output signal 94 by a known gain factor while maintaining (or substantially maintaining) at least a portion of the content (e.g., the spectral content and/or the temporal content) of analog sensor output signal 94. For example, pre-amplifier sub-unit 122 may pre-amplify analog sensor output signal 94 by a known gain factor while maintaining ratios between frequencies and maintaining ratios between phase shifts of analog sensor output signal 94. The gain factor may be predefined and/or may be modified by a user of device 101. Accordingly, analog activation signal 129 may be stronger than analog sensor output signal 94, while spectral content of analog activation signal 129 may remain unchanged as compared to spectral content of analog sensor output signal 94.

In some embodiments, the gain factor of pre-amplifier sub-unit 122 may be determined based on a known attenuation of the fiber optic cable (e.g., in order to compensate for the attenuation thereof). In some embodiments, the gain factor of pre-amplifier sub-unit 122 may be determined to enhance a sensitivity of sensing at a respective coupling location along the fiber optic cable. In some embodiments, the gain factor of pre-amplifier sub-unit 122 may be determined to balance spatial sensing sensitivity of the fiber optic cable due to effects associated with coherence and/or polarization thereof.

In some embodiments, pre-amplifier sub-unit 122 may eliminate a need in a power supply to sensor 90 being coupled to the fiber optic cable. Sensor 90 that does not have the power supply may generate relatively weak analog sensor output signal 94. The gain factor of the pre-amplifier sub-unit 122 may be determined to compensate this weak analog sensor output signal 94 such that pre-amplifier sub-unit 122 may pre-amplify analog sensor output signal 94 to a desired level.

In some embodiments, analog processing unit 120 may include an analog spectral content adapter sub-unit 124. Analog spectral content adapter sub-unit 124 may receive analog sensor output signal 94 from interface 110 and adapt the spectral content of analog sensor output signal 94 to provide an analog signal 125. In some embodiments, analog spectral content adapter sub-unit 124 may adapt the spectral content of analog sensor output signal 94 to provide an analog signal 125 that maintains (or substantially maintains) at least a portion of the spectral content of analog sensor output signal 94. For example, analog spectral content adapter sub-unit 124 may adapt the spectral content of analog sensor output signal 94 to provide an analog signal 125 that maintains (or substantially maintains) ratios between frequencies and maintains ratios (or substantially maintains) between phase shifts of analog sensor output signal 94.

For example, analog spectral content adapter sub-unit 124 may shift the spectral content of analog sensor output signal 94 by a known shift frequency value to provide analog signal 125 (e.g., wherein analog signal 125 may maintain (or substantially maintain) ratios between frequencies and may maintain ratios (or substantially maintain) between phase shifts of analog sensor output signal 94). In another example, analog spectral content adapter sub-unit 124 may divide/multiply the spectral content of analog sensor output signal 94 by a known division/multiplication value to provide analog signal 125 (e.g., wherein analog signal 125 may maintain (or substantially maintain) ratios between frequencies and may maintain ratios (or substantially maintain) between phase shifts of analog sensor output signal 94). In another example, analog spectral content adapter sub-unit 124 may mix the spectral content of analog sensor output signal 94 with a reference oscillator to provide analog signal 125. In another example, analog spectral content adapter sub-unit 124 may apply a spectral filter (e.g., band pass filter, high pass filter, etc.) on the spectral content of analog sensor output signal 94 to provide analog signal 125. In another example, analog spectral content adapter sub-unit 124 may multiply the spectral content of analog sensor output signal 94 by a linear phase term (e.g., to temporally shift the temporal signal by a factor proportional to the linear phase term) to provide analog signal 125. In another example, analog spectral content adapter sub-unit 124 may apply a non-linear transformation on the spectral content of analog sensor output signal 94 to provide analog signal 125.

Analog signal 125 may be inputted to pre-amplifier sub-unit 122 for pre-amplifying thereof to provide analog activation signal 129 (e.g., as discussed above). In some embodiments, analog spectral content adapter sub-unit 124 may adapt the spectral content of analog sensor output signal 94 based on specifications of an interrogator to be used with the fiber optic cable and/or the length of the fiber optic cable to enhance the sensing capabilities of thereof. In some embodiments, analog spectral content adapter sub-unit 124 may adapt the spectral content of analog sensor output signal 94 to enable a Frequency-Division-Multiplexing (FDM) of several sensors to the same sensing section of multiple sensing sections of fiber optic cable while eliminating crosstalk artifacts.

In some embodiments, analog preprocessing unit 120 may include a power source 126. Power source 126 may supply power to components of analog preprocessing unit 120 (e.g., pre-amplifier sub-unit 122 and/or analog spectral content adapter sub-unit 124) for a time period ranging between few months to few years. For example, power source 126 may include one or more type C batteries. In some embodiments, power source 126 may include an interface to an external power supply system.

In some embodiments, analog preprocessing unit 120 may include a quantification sub-unit 127. Quantification sub-unit 127 may receive analog sensor output signal 94 from sensor 90. Quantification sub-unit 127 may determine whether analog sensor output signal 94 is above one or more sensor output thresholds. If analog sensor output signal 94 is above one of the sensor output threshold(s), quantification sub-unit 127 may generate an analog quantification signal 128 according to predetermined quantification rules. Analog quantification signal 128 may be predetermined to be indicative concerning which of the one or more thresholds (if any) has been passed by analog sensor output signal 94. For example, if analog sensor output signal 94 is above a first sensor output threshold, quantification sub-unit 127 may, for example, generate a sinusoidal analog quantification signal 128 having a first frequency. In another example, if analog sensor output signal 94 is above a second sensor output threshold, quantification sub-unit 127 may, for example, generate a sinusoidal analog quantification signal 128 having a second frequency. Analog quantification signal 128 may be inputted into pre-amplifier sub-unit 122 to pre-amplify analog quantification signal 128 and generate analog activation signal 129 that is correlative with analog quantification signal 128.

In some embodiments, activation unit 130 may receive analog activation signal 129 from analog preprocessing unit 120. Activation unit 130 may be configured to change one or more properties of at least one of: (i) one or more optical wave propagating through the at least one optical fiber, (ii) and the at least one optical fiber, with respect to analog activation signal 129. For example, the properties of the optical wave(s) may include a phase, polarization, optical interference, etc. of the optical wave(s). The properties of the at least one optical fiber may, for example, include density, strain, etc. of the at least one optical fiber. In another example, the properties may include interaction of the optical wave(s) with respect to each other and/or with the at least one optical fiber.

Reference is now made to FIG. 2, which is a schematic illustration of an activation unit 230 for external coupling thereof to a fiber optic cable, according to some embodiments of the invention.

Illustration 200a in FIG. 2 schematically shows activation unit 230. Illustration 200b in FIG. 2 schematically shows activation unit 230 coupled to a fiber optic cable 80. Fiber optic cable 80 may include at least one optical fiber.

Activation unit 230 may be similar to, for example, activation unit 130 described above with respect to FIGS. 1A and 1B. In some embodiments, activation unit 230 may include one or more vibrational members 232. For example, in embodiments shown in FIG. 2, activation unit 230 includes two vibrational members 232—a first vibrational member 232a and a second vibrational member 232b. Vibrational member(s) 232 may be couplable, or removably couplable, to fiber optic cable 80 at a coupling location along fiber optic cable 80. Vibrational member(s) 232 may at least partly embrace fiber optic cable 80 when coupled thereto. Vibrational member(s) 232 may be externally couplable to fiber optic cable 80 without a need in cutting fiber optic cable 80.

Vibrational member(s) 232 may vibrate in response to an analog sensor output signal or an analog activation signal. The vibrations may be correlative to the analog activation signal and/or correlative to the analog sensor output signal from a sensor signal (e.g., such as analog activation signal 129 and an analog sensor output signal 94 described above with respect to FIGS. 1A and 1B). In some embodiments, the vibrations may maintain (or substantially maintain) at least a portion of the content (e.g., the spectral content and/or the temporal content) of the analog activation signal and/or maintain at least a portion of the content (e.g., the spectral content and/or the temporal content) of the analog sensor output signal.

Vibrational member(s) 232 may vibrate fiber optic cable 80 at least in the coupling location and induce at least one physical change in the at least one optical fiber at least in the coupling location along fiber optic cable 80. The physical change thereof may change the one or more properties of at least one of: one or more optical wave propagating through the at least one optical fiber and the at least one optical fiber (e.g., as described above with respect to FIGS. 1A and 1B). The change thereof may be correlative to the analog activation signal and thus correlative to the analog sensor output signal from the sensor signal. In some embodiments, the changes thereof may maintain (or substantially maintain) at least a portion of the content (e.g., the spectral content and/or the temporal content) of the analog activation signal and/or maintain at least a portion of the content (e.g., the spectral content and/or the temporal content) of the analog sensor output signal. Vibrational member(s) 232 may vibrate in a coherent manner with respect to each other to enhance the at least one physical change in fiber optic cable 80.

In various embodiments, vibrational member(s) 232 may be made of piezoelectric-based materials, electrostriction-based materials and electromagnetic-effectible materials. The materials of vibrational member(s) 232 may be rigid enough such that vibrational member(s) 232 may be capable of deforming the fiber optic cable, while preventing undesired deformation of the vibrational member(s) 232 by the fiber optic cable. Vibrational member(s) 232 may be capable of vibrating at a frequency range that may enable effective sensing of desired physical field(s).

Reference is now made to FIG. 3, which is a schematic illustration of an activation unit 330 for in-line coupling thereof to a fiber optic cable, according to some embodiments of the invention.

Illustration 300a in FIG. 3 schematically shows activation unit 330. Illustration 300b in FIG. 3 schematically shows activation unit 330 coupled to fiber optic cable 80. Fiber optic cable 80 may include at least one optical fiber.

Activation unit 330 may be similar to, for example, activation unit 130 described above with respect to FIGS. 1A and 1B. In some embodiments, activation unit 330 may include one or more vibrational members 332 and an activation unit optical fiber 334. Vibrational members 332 may be similar to vibrational members 232 described above with respect to FIG. 2. In embodiments shown in FIG. 3, activation unit 330 includes a first vibrational member 332a and a second vibrational member 332b that at least partly embrace activation unit optical fiber 334.

In some embodiments, activation unit 330 may include one or more optical couplers 336. In embodiments shown in FIG. 3, activation unit 330 includes a first optical coupler 336a and a second optical coupler 336b. Optical coupler(s) 336 may be connected to ends of activation unit optical fiber 334 (e.g., as shown in FIG. 3).

In order to couple activation unit 330 to fiber optic cable 80, a portion 82 of fiber optic cable 80 may be cutoff and replaced with activation unit 330, wherein free ends 83 of uncut portions 84 of fiber optic cable 80 may be connected to activation unit optical fiber 334 using optical coupler(s) 336 thereof (e.g., as shown in FIG. 3).

Vibrational member(s) 332 may vibrate in response to an analog sensor output signal or in response to an analog activation signal. The vibrations may be correlative to the analog activation signal and/or correlative to the analog sensor output signal from a sensor signal (e.g., such as analog activation signal 129 and an analog sensor output signal 94 described above with respect to FIGS. 1A and 1B). In some embodiments, the vibrations may maintain (or substantially maintain) at least a portion of the content (e.g., the spectral content and/or the temporal content) of the analog activation signal and/or maintain at least a portion of the content (e.g., the spectral content and/or the temporal content) of the analog sensor output signal.

Vibrational member(s) 332 may vibrate activation unit optical fiber 334 and induce at least one physical change in activation unit optical fiber 334. The physical change thereof may change one or more properties of at least one of: one or more optical wave propagating through activation unit optical fiber 334 and activation unit optical fiber 334. The change thereof may induce a change of one or properties of at least one of: one or more optical wave propagating through the at least one optical fiber of fiber optic cable 72 and the at least one optical fiber of fiber optic cable 72. The change thereof may be correlative to the analog activation signal and thus correlative to the analog sensor output signal from the sensor signal. In some embodiments, the changes thereof may maintain (or substantially maintain) at least a portion of the content (e.g., the spectral content and/or the temporal content) of the analog activation signal and/or maintain at least a portion of the content (e.g., the spectral content and/or the temporal content) of the analog sensor output signal. Vibrational member(s) 332 may vibrate in a coherent manner with respect to each other to enhance the at least one physical change activation unit optical fiber 334.

Activation unit 330 may, for example, enable an effective coupling of vibrations. For example, activation unit optical fiber 334 may be selected independent of fiber optic cable 80. In another example, activation unit optical fiber 334 may be turned around vibrational member(s) 332 such that coupling of inventions may increase with each turn.

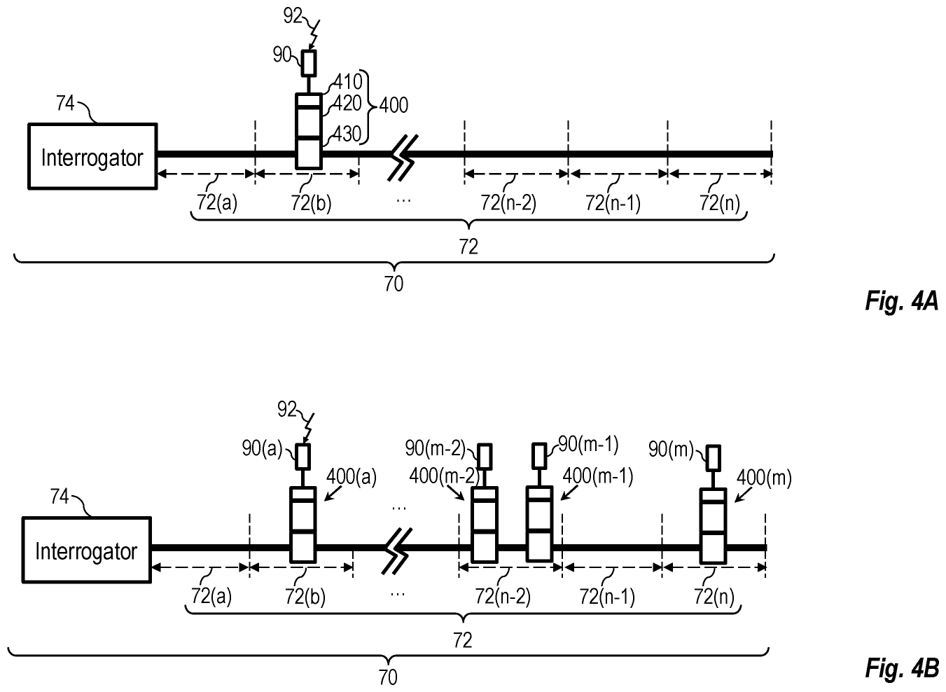

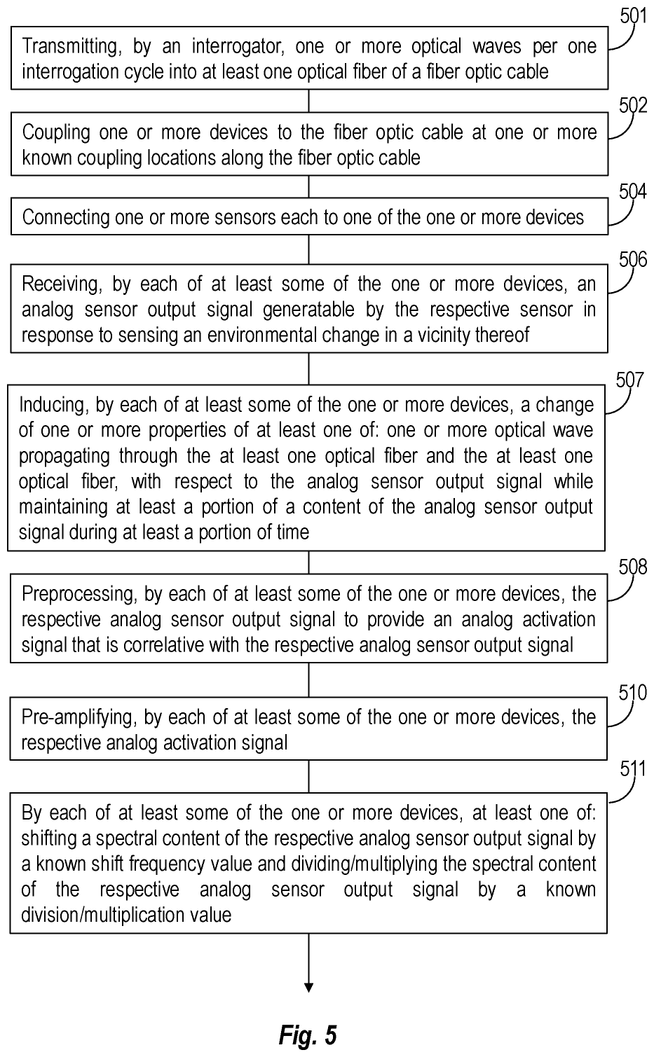

Reference is now made to FIG. 4A, which is a schematic illustration of a device 400 for coupling a sensor 90 to a fiber optic cable, in operation in a distributed fiber sensing system 70, according to some embodiments of the invention.

Distributed fiber sensing system 70 may include a fiber optic cable 72 and an interrogator 74. Fiber optic cable 72 may include at least one optical fiber. Interrogator 74 may be connected to, for example, one of ends of fiber optic cable 72. Interrogator 74 may virtually divide fiber optic cable 72 into multiple sensing sections 72(a) . . . 72(n) (e.g., resolution cells). Interrogator 74 may transmit one or more optical waves of light per one interrogation cycle into fiber optic cable 72.

In some embodiments, device 400 may be similar to device 101 described above with respect to FIG. 1B. In some embodiments, device 400 may include an interface 410, an analog preprocessing unit 420 and an activation unit 430. Interface 410 and analog preprocessing unit 420 may be similar to, for example, interface 110 and analog preprocessing unit 120, respectively, described above with respect to FIG. 1B. Activation unit 430 may be similar to, for example, activation unit 130, activation unit 230 or and activation unit 330 described above with respect to FIGS. 1B, 2 and 3, respectively.

In some embodiments, device 400 may be similar to device 100 described above with respect to FIG. 1A. In these embodiments, device 400 may include activation unit 430 only.

Device 400 (e.g., activation unit 430 thereof) may be couplable, or removably couplable, to a coupling location in any of sensing sections 72(a) . . . 72(n) along fiber optic cable 72 (e.g., as described above with respect to FIGS. 1A, 1B, 2 and 3). For example, device 400 may be externally or in-line coupled to in any of sensing sections 72(a) . . . 72(n) along fiber optic cable 72 (e.g., as described above with respect to FIG. 2 and FIG. 3, respectively).

Interface 410 of device 400 may connect sensor 90 to device 400 (e.g., as described above with respect to FIGS. 1A and 1B). Sensor 90 may sense 92 an environmental change in a vicinity thereof and generate an analog sensor output signal (e.g., such as analog sensor output signal 94 described above with respect to FIGS. 1A and 1B).

In some embodiments, interface 410 may receive the analog sensor output signal from sensor 90 coupled thereto and transmit the analog sensor output signal to activation unit 430 that may change one or more properties of at least one of: one or more optical wave propagating through the at least one optical fiber and the at least one optical fiber, with respect to the analog sensor output signal (e.g., as described above with respect to FIGS. 1A and 1B). In some embodiments, activation unit 430 may change the one or more properties of at least one of: (i) one or more optical waves propagating through the at least one optical fiber, and (ii) the at least one optical fiber, with respect to analog sensor output signal 94 while maintaining (or substantially maintaining) at least a portion of a content (e.g., a spectral content and/or a temporal content) of analog sensor output signal 94 (e.g., as described above with respect to FIGS. 3A and 3B). In some embodiments, activation unit 430 may change the one or more properties of at least one of: (i) one or more optical waves propagating through the at least one optical fiber, and (ii) the at least one optical fiber, with respect to analog sensor output signal 94 while maintaining (or substantially maintaining) at least a portion of a content (e.g., a spectral content and/or a temporal content) of analog sensor output signal 94 during at least a portion of time (e.g., as described above with respect to FIGS. 3A and 3B).

In some embodiments, interface 410 may receive the analog sensor output signal from sensor 90 coupled thereto and transmit the analog sensor output signal to analog preprocessing unit 420 (e.g., as described above with respect to FIGS. 1A and 1B). Analog preprocessing unit 420 may preprocess the analog sensor output signal to provide an analog activation signal (e.g., such as analog activation signal 129 described above with respect to FIGS. 1A and 1B). The analog activation signal may be correlative with the analog sensor output signal (e.g., as described above with respect to FIG. 1B). In some embodiments, the analog activation signal may maintain (or substantially maintain) at least a portion of the content (e.g., the spectral content and/or the temporal content) of the analog sensor output signal. In some embodiments, the analog activation signal may maintain (or substantially maintain) at least a portion of the content (e.g., the spectral content and/or the temporal content) of the analog sensor output signal during at least a portion of time. For example, the change induced by activation unit 430 may maintain (or substantially maintain) the content of the analog activation signal and thus maintain (or substantially maintain) the content of the analog sensor output signal from sensor 90. Activation unit 430 may receive the analog activation signal and change one or more properties of at least one of: (i) one or more optical wave propagating through the at least one optical fiber, and (ii) the at least one optical fiber, with respect to the analog activation signal (e.g., as described above with respect to FIG. 1B).

Interrogator 74 may detect the optical wave(s) from at least some points along the at least one optical fiber of fiber optic cable 72 and analyze the detected optical wave(s) with respect to known operating parameters of interrogator 74. For example, interrogator 74 may analyze non-linear optical effects and/or temporal variations of Rayleigh based scattering.

Interrogator 74 may detect, based on the analysis thereof, the induced change along the at least one optical fiber of fiber optic cable 72, wherein the change thereof may be indicative of the environmental change being sensed 92 by sensor 90 coupled to device 400. The change induced by activation unit 430 may be correlative with the analog activation signal and thus correlative with the analog sensor output signal from sensor 90. Accordingly, the change induced by activation unit 430 may be inherently detectable by any interrogator 74, independent of a type thereof, without a need in any additional post-processing. In this manner, device 400 may be easily retrofitted to any operating distributed fiber sensing system, while eliminating (or substantially eliminating) a need in performing adaptations to the system.

In some embodiments, analog preprocessing unit 420 of device 400 may determine whether the analog sensor output signal is above one or more sensor output thresholds, and if so generating the analog activation signal according to predetermined quantification rules to carry information concerning which of the one or more thresholds (if any) has been passed by the analog sensor output signal (e.g., as described above with respect to FIG. 1B). Interrogator 74 may determine, based on the analysis of the detected optical wave(s), that sensor 90 coupled to device 400 has sensed an environmental change that is above one or more thresholds. For example, if sensor 90 is a thermometer, interrogator 74 may determine that a temperature sensed by the thermometer has passed one or more temperature thresholds.

Reference is now made to FIG. 4B, which is a schematic illustration of multiple devices 400(a) . . . 400(m) for coupling multiple sensors 90(a) . . . 90(m) to a fiber optic cable, in operation in distributed fiber sensing system 70, according to some embodiments of the invention.

In some embodiments, multiple devices 400(a) . . . 400(m), e.g., application units thereof, may be couplable (or removably couplable) to multiple sensors 90(a) . . . 90(m) and to multiple coupling locations in any of sensing sections 72(a) . . . 72(n) along fiber optic cable 72.

Interrogator 74 may identify a sensing section of sections 72(a) . . . 72(n) along fiber optic cable 72 in which the change has been induced, and thus identify a device of multiple devices 400(a) . . . 400(m) that has induced the change thereof and a sensor of multiple sensors 90(a) . . . 90(m) that has sensed 92 the environmental change in a vicinity thereof. In example shown in FIG. 4B, interrogator 74 may identify that the change has been induced by device 400(a) coupled to fiber optic cable 72 in a first section 72(a) thereof, which may be indicative that a first sensor 90(a) has sensed 92 the environmental change in a vicinity thereof.

In some embodiments, devices 400(a) . . . 400(m) may enable multiplexing two or more sensors to the single sensing section of sensing sections 72(a) . . . 72(n) along fiber optic cable 72 while eliminating crosstalk artifacts therebetween. For example, two or more of multiple devices 400(a) . . . 400(m) may be coupled at corresponding coupling locations in a single sensing section of sensing sections 72(a) . . . 72(n) along fiber optic cable 72. In example shown in FIG. 4B, two devices 400(m-2), 400(m-1) are coupled to sensors 90(m-2), 90(m-1), respectively, and are coupled at corresponding two coupling locations in a single section 72(n-2) along fiber optic cable 72.

In some embodiments, the spectral content of the analog sensor output signal of at least one of sensors 90(m-2), 90(m-1) coupled by devices 400(m-2), 400(m-1), respectively, to fiber optic cable 72 in the single sensing section thereof may be shifted by a known shift frequency value and/or divided/multiplied by a known division/multiplication value (e.g., Frequency-Division-Multiplexing, as described above with respect to FIG. 1B), for example while maintaining (or substantially maintaining) ratios between frequencies and maintaining ratios between phase shifts of the analog sensor output signal. This may, for example, enable interrogator 74 to distinguish between the changes induced by each of devices 400(m-2), 400(m-1) coupled to fiber optic cable 72 in the single sensing section thereof and to identify which of sensors 90(m-2), 90(m-1) has sensed the environmental change in a vicinity thereof.

In some embodiments, a calibration process may be required to enable interrogator 74 to determine where along fiber optic cable 72 the change has occurred. The calibration process may be performed during, for example, an installing of devices 400(a) . . . 400(m) onto fiber optic cable 72. For example, during installation, an operator may continuously read signals from different positions along fiber optic cable 72. During coupling of each of devices 400(a) . . . 400(m), a field technician may inform the operator concerning the exact coupling location of the respective device and a type of the sensor to be coupled using the respective device. Upon installation, fiber optic cable 72 may be exposed to substantially changes and the operator, that may observe these changes, may determine and record the exact location thereof and thus the exact location of the respective device and the sensor. The calibration results may be stored in a database and used by interrogator 74 for determining where along fiber optic cable 72 the change has occurred.

Some embodiments of the present invention may include a fiber optic cable of one or more optical fibers, and one or more devices for coupling a sensor to the fiber optic cable, wherein the activation unit of each of the one or more devices is rigidly coupled (e.g., welded or soldered) to the fiber optic cable at a known coupling location. For example, fiber optic cable 72 described above with respect to FIGS. 4A and 4B and one or more devices 100 or devices 400 described above with respect to FIGS. 1A and 1B and FIGS. 4A and 4B, respectively.

Some embodiments of the present invention may provide a distributed fiber sensing system. The distributed fiber sensing system may include one or more devices for coupling a sensor to a fiber optic cable (e.g., such as device 100 or device 400 described above with respect to FIGS. 1A and 1B and FIGS. 4A and 4B, respectively). In some embodiments, the distributed fiber sensing system may include an interrogator (e.g., such as interrogator 74 described above with respect to FIG. 4). In some embodiments, the distributed fiber sensing system may further include a fiber optic cable of one or more optical fibers (e.g., such as fiber optic cable 72 described above with respect to FIGS. 4A and 4B). In some embodiments, the distributed fiber sensing system may include one or more sensors (e.g., such as sensor 90 described above with respect to FIGS. 1A, 1B and 4). In some embodiments, the distributed fiber sensing system may include the fiber optic cable of one or more optical fibers, and one or more devices for coupling a sensor to the fiber optic cable, wherein the activation unit of each of the one or more devices is rigidly coupled (e.g., welded or soldered) to the fiber optic cable at a known coupling location.

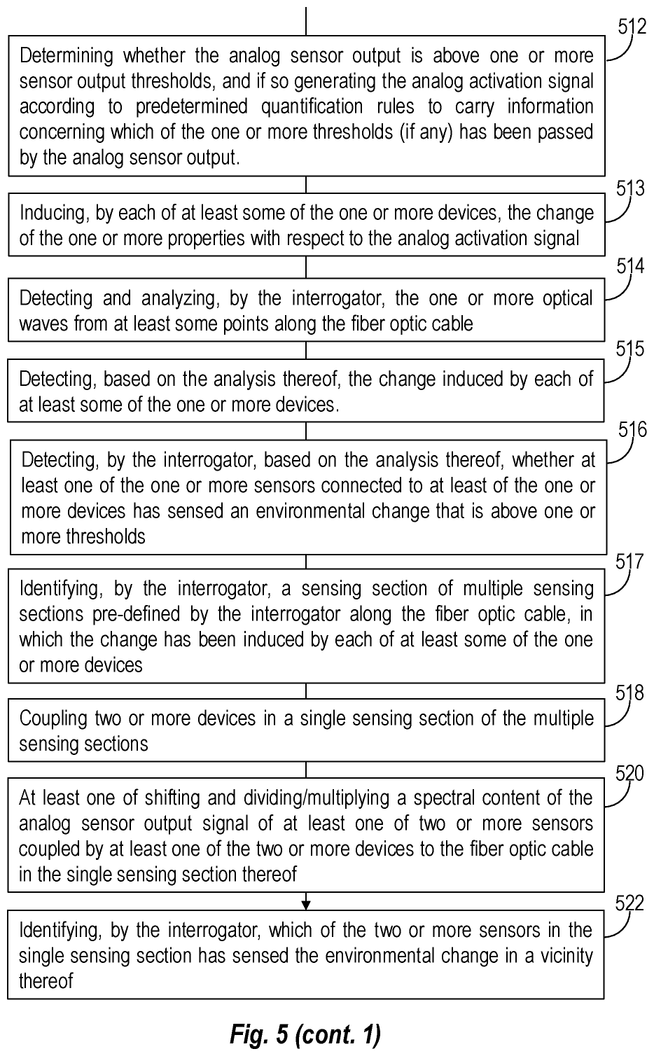

Reference is now made to FIG. 5, which is a flowchart of a method of distributed fiber sensing, according to some embodiments of the invention.

It is noted that the method is not limited to the flowcharts illustrated in FIG. 5 and to the corresponding description. For example, in various embodiments, the method needs not move through each illustrated box or stage, or in exactly the same order as illustrated and described.

Some embodiments may include transmitting, by an interrogator, one or more optical waves per one interrogation cycle into at least one optical fiber of a fiber optic cable (stage 501). For example, as described above with respect to FIG. 4A.

Some embodiments may include coupling one or more devices to the fiber optic cable at one or more known coupling locations along the fiber optic cable (stage 502). For example, device 100, device 101 or device 400 described above with respect to FIGS. 1A, 1B and 4A, respectively. In various embodiments, the coupling may be external (e.g., as described above with respect to FIG. 2) or in-line (e.g., as described above with respect to FIG. 3). In some embodiments, the coupling may be rigid. For example, each of the one or more devices may be rigidly coupled (e.g., welded or soldered) to the fiber optic cable at a known coupling location.

Some embodiments may include connecting one or more sensors each to one of the one or more devices (stage 504). For example, sensor 90 described above with respect to FIGS. 1A, 1B and 4A.

Some embodiments may include receiving, by each of at least some of the one or more devices, an analog sensor output signal generatable by the respective sensor in response to sensing an environmental change in a vicinity thereof (stage 506). For example, as described above with respect to FIGS. 1A, 1B and 4A.

Some embodiments may include inducing, by each of at least some of the one or more devices, a change of one or more properties of at least one of: (i) one or more optical wave propagating through the at least one optical fiber, and (ii) the at least one optical fiber, with respect to the analog sensor output signal while maintaining (or substantially maintaining) at least a portion of a content (e.g., a spectral content and/or a temporal content) of the analog sensor output signal during at least a portion of time (stage 507). For example, as described above with respect to FIGS. 1A and 4A.

Some embodiments may include preprocessing, by each of at least some of the one or more devices, the respective analog sensor output signal to provide an analog activation signal that is correlative with the respective analog sensor output signal (stage 508). For example, as described above with respect to FIGS. 1B and 4A.

Some embodiments may include pre-amplifying, by each of at least some of the one or more devices, the respective analog activation signal (stage 510). For example, as described above with respect to FIG. 1B.

Some embodiments may include, by each of at least some of the one or more devices, at least one of: shifting a spectral content by a known shift frequency value and dividing/multiplying the spectral content by a known division/multiplication value of the respective analog sensor output signal (stage 511). For example, as described above with respect to FIG. 1B.

Some embodiments may include determining whether the analog sensor output signal is above one or more sensor output thresholds, and if so generating the analog activation signal according to predetermined quantification rules to carry information concerning which of the one or more thresholds (if any) has been passed by the analog sensor output signal (stage 512). For example, as described above with respect to FIGS. 1B and 4A.

Some embodiments may include inducing, by each of at least some of the one or more devices, the change of the one or more properties with respect to the analog activation signal (stage 513). For example, as described above with respect to FIGS. 1B, 2, 3, 4A and 4B.

Some embodiments may include detecting and analyzing, by the interrogator, the one or more optical waves from at least some points along the fiber optic cable (stage 514). For example, as described above with respect to FIG. 4A.

Some embodiments may include detecting, by the interrogator, based on the analysis thereof, the change induced by each of at least some of the one or more devices (stage 515). For example, as described above with respect to FIG. 4A.

Some embodiments may include detecting, by the interrogator, based on the analysis thereof, whether at least one of the one or more sensors connected to at least of the one or more devices has sensed an environmental change that is above one or more thresholds (stage 516). For example, as described above with respect to FIG. 4A.

Some embodiments may include identifying, by the interrogator, a sensing section of multiple sensing sections pre-defined by the interrogator along the fiber optic cable, in which the change has been induced by each of at least some of the one or more devices (stage 517). For example, as described above with respect to FIG. 4B.

Some embodiments may include coupling two or more devices in a single sensing section of the multiple sensing sections (stage 518). For example, as described above with respect to FIG. 4B.

Some embodiments may include at least one of shifting and dividing/multiplying a spectral content of the analog sensor output signal of at least one of two or more sensors coupled by at least one of the two or more devices to the fiber optic cable in the single sensing section thereof (stage 520). For example, as described above with respect to FIG. 4B.

Some embodiments may include identifying, by the interrogator, which of the two or more sensors in the single sensing section has sensed the environmental change in a vicinity thereof (stage 522). For example, as described above with respect to FIG. 4B.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A device for coupling a sensor to a fiber optic cable including at least one optical fiber, the device comprising:
an analog preprocessing unit configured to:
receive an analog sensor output signal from the sensor, and
preprocess the analog sensor output signal to provide an analog activation signal that is correlative with the analog sensor output signal at a correlation level sufficient to maintain the temporal content and the spectral content of the analog sensor output signal; and
an activation unit couplable to a known coupling location along the fiber optic cable and configured to:
receive the analog activation signal from the analog preprocessing unit, and
change one or more properties of at least one of: one or more optical wave propagating through the at least one optical fiber and the at least one optical fiber, with respect to the analog activation signal while maintaining the temporal content and the spectral content of the analog sensor output signal.

2. The device of claim 1, wherein the analog preprocessing unit comprises an analog spectral content adapter sub-unit configured to provide the analog activation signal by at least one of: shifting a spectral content of the analog sensor output signal by a known shift frequency value and dividing/multiplying the spectral content of the analog sensor output signal by a known division/multiplication value, while maintaining ratios between frequencies and maintaining ratios between phase shifts of the analog sensor output signal.

3. The device of claim 1, wherein the analog preprocessing unit comprises a power source for supplying power to the analog preprocessing unit.

4. The device of claim 1, wherein the activation unit comprises one or more vibrational members externally couplable to the coupling location along the fiber optic cable, the one or more vibrational members vibrate in response to the analog activation signal thereby vibrating the fiber optic cable at least in the coupling location.

5. The device of claim 1, wherein the activation unit is configured to be in-line coupled at the coupling location along the fiber optic cable, the activation unit comprises:
an activation unit optical fiber;
two optical couplers each at one of ends of the activation unit optical fiber, the optical couplers are adapted to couple the activation unit optical fiber to the at least one optical fiber of the fiber optic cable; and
one or more vibrational members coupled to the activation unit optical fiber, the one or more vibrational members vibrate in response to the analog activation signal thereby vibrating the activation unit optical fiber.

6. The device of claim 4, wherein the one or more vibrational members are made of one of: piezoelectric materials, electrostriction materials and electromagnetic effectible materials.

7. The device of claim 1, wherein the sensor is a sensor capable of generating a transient sensor output signal.

8. A fiber optic cable of one or more optical fibers comprising one or more devices of claim 1, wherein the activation unit of each of the one or more devices is rigidly coupled to the fiber optic cable at a known coupling location.

9. A distributed fiber sensing system comprising:
(a) one of:
(i) a fiber optic cable of one or more optical fibers, and
one or more devices of claim 1, the activation unit of each of the one or more devices is couplable to the fiber optic cable at a known coupling location; and
(ii) a fiber optic cable comprising one or more devices of claim 1, wherein the activation unit of each of the one or more devices is rigidly coupled to the fiber optic cable at a known coupling location; and
(b) an interrogator.

10. A method of distributed fiber sensing, the method comprising:
transmitting, by an interrogator, one or more optical waves per one interrogation cycle into at least one optical fiber of a fiber optic cable;
coupling one or more devices to the fiber optic cable at one or more known coupling locations along the fiber optic cable;
connecting one or more sensors each to one of the one or more devices; and
by each of at least some of the one or more devices:
receiving an analog sensor output signal generatable by the respective sensor in response to sensing an environmental change in a vicinity thereof,
preprocessing the analog sensor output signal to provide an analog activation signal that is correlative with the analog sensor output signal at a correlation level sufficient to maintain the temporal content and the spectral content of the analog sensor output signal, and
inducing a change of one or more properties of at least one of: one or more optical wave propagating through the at least one optical fiber and the at least one optical fiber, with respect to the analog activation signal while maintaining the temporal content and the spectral content of the analog sensor output signal.

11. The method of claim 10, further comprising, by each of at least some of the one or more devices, providing the analog activation signal by at least one of: shifting a spectral content of the respective analog sensor output signal by a known shift frequency value and dividing/multiplying the spectral content of the respective analog sensor output signal by a known division/multiplication value while maintaining ratios between frequencies and maintaining ratios between phase shifts of the respective analog sensor output signal.

12. The method of claim 10, further comprising detecting and analyzing, by the interrogator, the one or more optical waves from at least some points along the fiber optic cable.

13. The method of claim 12, further comprising detecting, by the interrogator, based on the analysis thereof, the change induced by each of at least some of the one or more devices.

14. The method of claim 13, further comprising detecting, by the interrogator, based on the analysis thereof, whether at least one of the one or more sensors connected to at least of the one or more devices has sensed an environmental change that is above one or more thresholds.

15. The method of claim 13, further comprising identifying, by the interrogator, a sensing section of multiple sensing sections pre-defined by the interrogator along the fiber optic cable, in which the change has been induced by each of at least some of the one or more devices.

16. The method of claim 15, further comprising coupling two or more devices in a single sensing section of the multiple sensing sections while eliminating crosstalk therebetween.

17. The method of claim 16, further comprising:
at least one of shifting and dividing/multiplying a spectral content of the analog sensor output signal of at least one of two or more sensors coupled by at least one of the two or more devices to the fiber optic cable in the single sensing section thereof; and
identifying, by the interrogator, which of the two or more sensors in the single sensing section has sensed the environmental change in a vicinity thereof.
